(19) United States
(12) Patent Application Publication
(10) Pub. No.: US 2010/0093891 A1
(43) Pub. Date: Apr. 15, 2010

(54) Self-Viscosifying and Self-Breaking Gels

(76) Inventors: Leiming Li, Sugar Land, TX (US); Syed Ali, Sugar Land, TX (US); Richard D. Hutchins, Sugar Land, TX (US); Lijun Lin, Sugar Land, TX (US); Curtis L. Boney, Houston, TX (US); Carlos Abad, Richmond, TX (US); Javier Sanchez Reyes, Katy, TX (US); Paul R. Howard, Sugar Land, TX (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/578,209

(22) Filed: Oct. 13, 2009

Related U.S. Application Data
(60) Provisional application No. 61/104,855, filed on Oct. 13, 2008.

(51) Int. Cl. C09K 8/44; C08F 20/00

(52) U.S. Cl. 523/130; 526/306

(57) ABSTRACT

The invention provides a method. The method injects into a wellbore, a fluid comprising at least one of an acrylamide polymer and an acrylamide copolymer, and at least one of an oxidizing agent and a radical initiator; and allows viscosity of the fluid to increase for a first period of time; and subsequently, allows viscosity of the fluid to decrease for a second period of time. In a further aspect the invention provides a fluid for use in a well within a subterranean formation penetrated by a wellbore. The fluid is in a first embodiment, made of an acrylamide polymer and/or copolymer and an oxidizing agent or radical initiator, wherein concentration of the oxidizing agent or radical initiator is such that the fluid increases its viscosity for a period of time and after said period of time decreases its viscosity. The fluid is in a second embodiment, made of an acrylamide polymer and/or copolymer and an oxidizing agent or radical initiator, wherein the oxidizing agent or radical initiator is such that the fluid increases its viscosity for a period of time and after said period of time decreases its viscosity.

### CROSS-REFERENCE TO RELATED APPLICATIONS

This application claims the benefit of U.S. Provisional Application No. 61/104,855, filed Oct. 13, 2008, which is incorporated herein by reference in its entirety.

### FIELD OF THE INVENTION

This invention relates generally to the art of making and using oilfield treatment gels that self-viscosify and self-break. More particularly it relates to fluids made of acrylamide polymer and/or copolymer and an oxidizing agent (oxidizer) or radical initiator and methods of using such fluids in a well from which oil and/or gas can be produced.

### BACKGROUND

The statements in this section merely provide background information related to the present disclosure and may not constitute prior art.

Hydrocarbons (oil, condensate, and gas) are typically produced from wells that are drilled into the formations containing them. For a variety of reasons, such as inherently low permeability of the reservoirs or damage to the formation caused by drilling and completion of the well, the flow of hydrocarbons into the well is undesirably low. In this case, the well is “stimulated,” for example using hydraulic fracturing, chemical (usually acid) stimulation, or a combination of the two (called acid fracturing or fracture acidizing).

Hydraulic fracturing involves injecting fluids into a formation at high pressures and rates such that the reservoir rock fails and forms a fracture (or fracture network). Proppants are typically injected in fracturing fluids after the pad to hold the fracture(s) open after the pressures are released. In chemical (acid) stimulation treatments, flow capacity is improved by dissolving materials in the formation.

In hydraulic and acid fracturing, a first, viscous fluid called a “pad” is typically injected into the formation to initiate and propagate the fracture. This is followed by a second fluid that contains a proppant to keep the fracture open after the pumping pressure is released. Granular proppant materials may include sand, ceramic beads, or other materials. In “acid” fracturing, the second fluid contains an acid or other chemical such as a chelating agent that can dissolve part of the rock, causing irregular etching of the fracture face and removal of some of the mineral matter, resulting in the fracture not completely closing when the pumping is stopped. Occasionally, hydraulic fracturing is done without a highly viscosified fluid (i.e., slick water) to minimize the damage caused by polymers or the cost of other viscosifiers.

When multiple hydrocarbon-bearing zones are stimulated by hydraulic fracturing or chemical stimulation, it is desirable to treat the multiple zones in multiple stages. In multiple zone fracturing, a first pay zone is fractured. Then, the fracturing fluid is diverted to the next stage to fracture the next pay zone. The process is repeated until all pay zones are fractured. Alternatively, several pay zones may be fractured at one time, if they are closely located with similar properties. Diversion may be achieved with various techniques including formation of a temporary plug.

The applicants found that it is possible to create a temporary plug with acrylamide polymer and allow it to be self-viscosifying and self-breaking with specific additives.

### SUMMARY

In a first aspect, a method is disclosed. The method injects into a wellbore, a fluid comprising at least one of an acrylamide polymer and an acrylamide copolymer, and at least one of an oxidizing agent and a radical initiator; and allows viscosity of the fluid to increase for a first period of time; and subsequently, allows viscosity of the fluid to decrease for a second period of time.

In a second aspect, a method of treating a subterranean formation from a wellbore is disclosed. The method injects into the wellbore, a fluid comprising at least one of an acrylamide polymer and an acrylamide copolymer, and at least one of an oxidizing agent and a radical initiator; treats the subterranean formation by allowing viscosity of the fluid to increase for a first period of time; and subsequently, allowing viscosity of the fluid to decrease for a second period of time.

In a third aspect, a fluid is disclosed. In a first embodiment, the fluid for use in a well within a subterranean formation penetrated by a wellbore is made of an acrylamide polymer and/or copolymer and an oxidizing agent or radical initiator, wherein concentration of the oxidizing agent or radical initiator is such that the fluid increases its viscosity for a period of time and after said period of time decreases its viscosity.

In second embodiment, the fluid for use in a well within a subterranean formation penetrated by a wellbore is made of an acrylamide polymer and/or copolymer and an oxidizing agent or radical initiator, wherein the oxidizing agent or radical initiator is such that the fluid increases its viscosity for a period of time and after said period of time decreases its viscosity.

### BRIEF DESCRIPTION OF THE DRAWINGS

FIG. 1 is a graph comparing viscosity over time at 79.4 deg C. for a fluid made up of 5% acrylamide sodium acrylate copolymer (without ammonium persulfate) and for a fluid made up of 5% acrylamide sodium acrylate copolymer and 0.12% ammonium persulfate.

FIG. 2 is a graph comparing viscosity over time at 79.4 deg C. for a fluid made up of 2.5% acrylamide sodium acrylate copolymer and 0.06% ammonium persulfate, for a fluid made up of 2.5% acrylamide sodium acrylate copolymer and 0.12% ammonium persulfate, and for a fluid made up of 2.5% acrylamide sodium acrylate copolymer and 0.24% ammonium persulfate.

FIG. 3 is a graph showing viscosity at 79.4 deg C. for a fluid made up of 2.5% acrylamide sodium acrylate copolymer and 0.24% sodium persulfate.

FIG. 4 is a graph comparing viscosity at 93.3 deg C. for a fluid made up of 3% petroleum oil-dispersed acrylamide sodium acrylate copolymer (no ammonium persulfate), and a fluid made up of 3% petroleum oil-dispersed acrylamide sodium acrylate copolymer and 0.24% ammonium persulfate.

FIG. 5 is a graph comparing viscosity at 93.3 deg C. for a fluid made up of 1.5 wt % polyacrylamide (no ammonium persulfate), and for a fluid made up of 1.5 wt % polyacrylamide and 0.06% ammonium persulfate.

### DETAILED DESCRIPTION

At the outset, it should be noted that in the development of any actual embodiments, numerous implementation-specific decisions must be made to achieve the developer's specific goals, such as compliance with system and business related constraints, which can vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating embodiments of the invention and should not be construed as a limitation to the scope and applicability of the invention. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range disclosed and enabled the entire range and all points within the range.

The low-viscosity aqueous solution of acrylamide polymers and/or copolymers can change into a high-viscosity (solid-like) gel in the presence of selected oxidizing agents or oxidizers or radical initiators. Oxidizing agent and oxidizer are used as synonyms herewith. The increased viscosity can then be reduced by itself after time.

In a first embodiment, the acrylamide sodium acrylate copolymer used here has a relatively low molecular weight (about 0.5 million). The oxidizer used herewith can be ammonium, potassium or sodium persulfate, at concentration for example of: 0.06%, 0.12%, or 0.24%. It is possible to tune the parameters such as gelling time (when the viscosity rises), gel lifetime, and gel breaking time through adjustment of the oxidizer concentration and oxidizer type. It is also possible to tune those parameters with the temperature. The oxidizers function in a dual mode in which they self-viscosify and self-break the gels.

The period of time could be changed with a time delayed system, for example methanol- or ethanol-generating ester, a polylactic acid, or a combination thereof.

In a second embodiment, the acrylamide sodium acrylate copolymer used here has a higher molecular weight than previously (about 5 million). As well, the oxidizer used herewith can be ammonium, potassium or sodium persulfate, at concentration for example of: 0.06%, 0.12%, or 0.24%.

In a third embodiment, self-breaking gels can contain nonionic polyacrylamide. As well, the oxidizer used herewith can be ammonium, potassium or sodium persulfate, at concentration for example of: 0.06%, 0.12%, or 0.24%.

The term acrylamide polymers as widely mentioned here includes polyacrylamide, partially hydrolyzed polyacrylamide, and polyacrylamide polyacrylic acid copolymers and derivatives and also sodium acrylate copolymers, acrylamide sodium acrylate copolymer or nonionic polyacrylamide, and can also include any other acrylamide polymers and copolymers that contain acrylamide units. The viscosification of the acrylamide polymer and/or copolymer solution in the presence of oxidizers such as ammonium persulfate may be induced by radical initiation and the subsequent transfer of the radical activity to the hydrogen alpha to the carboxyl group in the acrylamide units, and the subsequent combination to form crosslinking among the polymers. One may expect any other polymers with a tertiary hydrogen on a carbon adjacent to a carbonyl group such as esters, or amides to show the similar behaviors in the presence of the appropriate oxidizers, including acrylic polymers such as polyhydroxyethyl acrylate and/or copolymers such as polyacrylic acid, acrylate polymers and/or copolymers such as sodium polyacrylate (also named as acrylic sodium salt polymer). Acrylamido-methyl-propane sulfonate polymers and copolymers, and N,N, alkyl acrylamide copolymers and the like are other examples of polymers included in the term acrylamide polymers as described herein. Other polymers with a tertiary hydrogen on a carbon adjacent to a functional group such as vinyl polymers and/or copolymers such as polyvinyl alcohol copolymers can also be considered for these embodiments, etc.

Instead of an oxidizer, other radical initiator that can produce radical species and promote the similar viscosification process may be used, for example: azo compounds, organic peroxides, persulfate, etc.

In a further aspect, a post-cleaning of the self-breaking gels is possible. In the case where these gels or broken gels need to be cleaned away, a number of methods may be used. To dissolve the gel, either sodium chlorite or hydrogen peroxide breaker may be employed.

These gels are compatible with other fluids or material as for example hydrocarbons such as mineral oil, proppants or additives normally found in well stimulation.

Current embodiments can be used in various applications. In a first aspect, the gel can be used as temporary blocking agents. Injection of low molecular weight polymer (including acrylamide polymers and copolymers) plus a free radical initiator will probably minimize placement problems and, at the same time, lead to a very viscous, high molecular weight polymer that will plug or divert subsequent fluid to untreated zones. With sufficient free radical initiator, the polymer will then degrade and remove itself. Since the re-polymerization timing can be adjusted by concentrations of free radical initiator, the later-stage degradation can be controlled by other oxidizers (non free radical initiators) or coated oxidizers, including free radical initiators. Addition of crosslinkers can further enhance the plug, where sufficient oxidizer is present to later break the plug down.

The system may be used as a possible method to create a plug together with sand and/or fiber, for instance, in between stages on a fracturing treatment (very useful in slick water, where the same chemicals are used for friction reduction, or polyacrylamide, and molecular weight degradation, or breaker). This will be a non-permanent plug that can be set very fast upon contact with the bottomhole static temperature (BHST), and that only needs to last for as long as the stage above is being fractured. All of the plugs can be flowed back to surface as broken fluids. This system may also be used to create non-permanent plugs in natural fractures during slick water treatments. If the fracturing fluid is migrating through a natural fracture that you want to close, the polymer and breaker load can be increased during the treatment to plug the fracture and reduce the load again once the fluid loss is no longer a problem. Good diversion in high water cut wells is always a challenge. When an acidizing treatment is required to increase the productivity of the hydrocarbon-bearing zones, the water-based stimulation fluids favor the water-bearing zone over the hydrocarbon-bearing zone due to the relative permeability effects. Higher water cut often results because of the preferential stimulation of the water zone. This new temporary diverting agent is designed for diverting stimulation fluids away from the water zone into the oil zone.

This proposed fluid can be used in remedial cementing operations where the temporary plug can be spotted using coiled tubing below the perforated zone to withhold the pressure of cement squeezed and avoid any cement mixing. This plug will safely hold during the necessary period and reduce the amount of cement required to mill. Additionally it will reduce cement contamination.

This system may also be used as a kill pill to contain the reservoir pressure and allow safe working on the well. The conventional use of brines with specific density to control wellhead pressure can result in loss of the brine into formation during the operation, making posterior water recovery a long process. The use of these embodiments will reduce the pressure at surface while avoiding any losses to the formation.

The proposed fluid can be used in coiled tubing operations (e.g., recovering velocity strings from wells). The system can be used to retain pressure in wells during velocity string extraction in depleted wells.

Another application is non-permanent insulators during heavy oil modular dynamic testing (MDT) sampling. MDT is a tool used to recover representative samples of reservoir fluid from cased holes. For this purpose the fluid needs to be injected around the sampling port of the MDT to prevent the heat loss to the wellbore.

In a second aspect, the gel can be used as a permanent zone abandonment or water shutoff material. By utilizing the good injectivity of low molecular weight polymer with low viscosity, placement into a zone is easier. Following shutin, the re-polymerization reaction can occur, leading to the development of a very viscous plug. Inclusion of suitable crosslinkers such as chromium triacetate, polyethyleneimine or hexamethylentetramine plus phenyl acetate, chemicals capable of forming aldehydes and phenolics or a combination thereof will result in a more permanent plug. Note that the higher molecular weight polymer could not be injected into tighter matrix without exceeding the parting pressure for the reservoir. Also, even if injectivity is accomplished with higher molecular weight polymer, it will be at such a slow rate as to be uneconomic. Finally, the use of low molecular weight polymer for injection provides a low friction fluid in the tubing without the possibility of shear degradation of the fluid, allowing the treatment to be done at higher injection rates with reduced workover time.

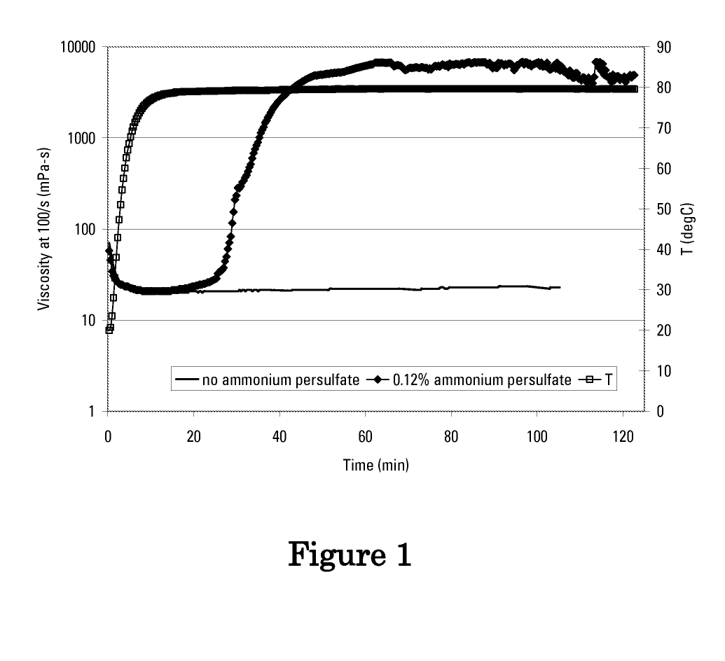

It is quite flexible to choose the desired molecular weight of the acrylamide polymers and/or copolymers without worrying about whether the re-polymerization will occur or not. High molecular weight polyacrylamides, such as brine or petroleum oil-dispersed acrylamide sodium acrylate copolymers, can be chosen when limiting the fluid leakoff into the matrix is desired. If the leakoff is not a concern, lower molecular weight polyacrylamide, such as acrylamide sodium acrylate copolymer, can be used as the startup polymer (for further polymerization induced with ammonium persulfate or other effective breakers) for better formation penetration. Usually by carefully control the amount of the breaker applied, the polyacrylamide will re-polymerize to certain extent and stop, resulting in a (relatively) “permanent” gel as shown in FIG. 1 for the gel made up of 5% acrylamide sodium acrylate copolymer and 0.12% ammonium persulfate. The bottle test of the same gel is consistent with the viscometer result in FIG. 1. The gel could hold itself when the bottle was upside down after more than 3 days at about 82 deg C.

In a third aspect, the gel can be used as a delayed acting friction reducer. Injection of low molecular weight polyacrylamide polymers and/or copolymers with free radical initiator can be used to delay friction reduction via drag reduction mechanisms where situations suggest conventional drag reducing agents might degrade by mechanical shear.

To facilitate a better understanding of some embodiments, the following examples of embodiments are given. In no way should the following examples be read to limit, or define, the scope of the embodiments described herewith.

### EXAMPLES

Series of experiments were conducted to demonstrate properties of compositions and methods as disclosed above.

In a first example, the acrylamide sodium acrylate copolymer used here has a relatively low molecular weight (about 0.5 million). The acrylamide sodium acrylate copolymer powder was dissolved in water and allowed full hydration. The solution was then loaded into a Fann50-type viscometer with the appropriate amount of oxidizer added. The oxidizer used herewith is ammonium persulfate. In FIG. 1, the solution of 5% acrylamide sodium acrylate copolymer (without any ammonium persulfate, as the background) shows a viscosity of about 20 cP (20 mPa-s at a shear rate of 100/s) at 79.4 deg C. The fluid after viscosity measurement looked like a viscous liquid at room temperature. When 0.12% ammonium persulfate was added to the same solution of 5% acrylamide sodium acrylate copolymer, the fluid viscosity began to rise abruptly at about 26 minutes. This is likely due to the persulfate-induced free radical polymerization that increases the molecular weight of the copolymer, resulting in a rapid viscosity growth. At some point, the fluid of 5% acrylamide sodium acrylate copolymer and 0.12% ammonium persulfate becomes substantially devoid of free radicals and further polymerization stops, resulting in a flat viscosity profile in the end. When 0.24% ammonium persulfate was added to the same solution of 5% acrylamide sodium acrylate copolymer, the fluid viscosity began to rise at about 7 minutes and reached over 4000 cP within minutes. This earlier occurrence of the viscosity jump may be explained by the higher concentrations of free radicals produced from the higher level of ammonium persulfate (0.24% compared with the previous 0.12%). The measurement was stopped at about 14 minutes, and it was found that the fluid had turned into a rubber-like substance.

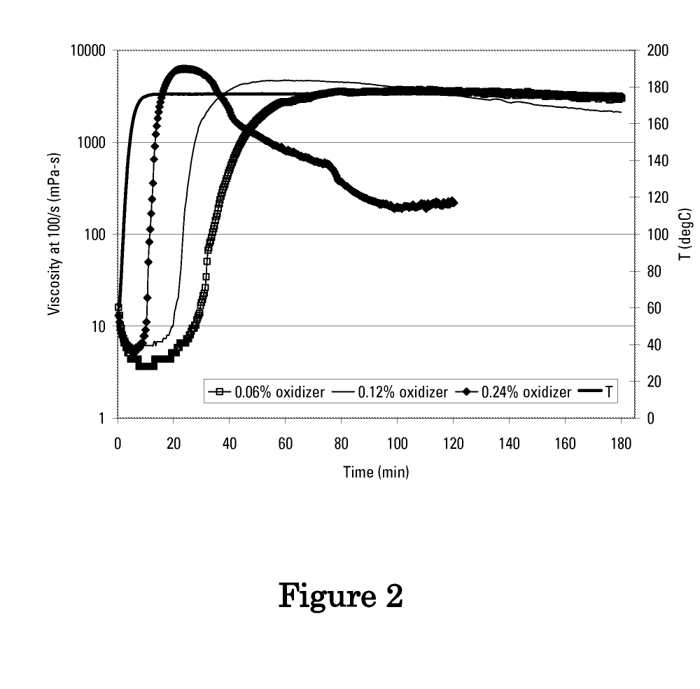

In another set of tests, different concentrations of oxidizer are used: 0.06%, 0.12%, and 0.24%, respectively. The oxidizer is still ammonium persulfate and is added to the solution of 2.5% of the acrylamide sodium acrylate copolymer. The viscosity was measured at 79.4 deg C. with the same viscometer, as shown in FIG. 2. FIG. 2 suggests that as the concentration of ammonium persulfate increases (from 0.06% to 0.24%), the delay it takes for the fluid viscosity to jump decreases accordingly (the delay is about 30 minutes for 0.06% ammonium persulfate, about 21 minutes for 0.12% ammonium persulfate, and about 10 minutes for 0.24% ammonium persulfate). When the concentration of ammonium persulfate is highest (i.e., 0.24%), the fluid viscosity reaches the maximum value, but then deteriorates fastest. When the concentration of ammonium persulfate is lowest (i.e., 0.06%), the fluid viscosity still reaches high values of about 3500 cP (at 100/s), and degrades very slowly afterwards. The comparison among the tested fluids suggests that tuning of the parameters such as gelling time (when the viscosity rises), gel lifetime, and gel breaking time by judicious adjustment of the oxidizer concentration is feasible.

The bottle tests were carried out in an oven at about 79-82 deg C. The polymer solution in the bottle was heated with a microwave oven to the desired temperature (79-82 deg C., for example), and breaker was then added and mixed. The bottle was put into the oven, and photos were taken at chosen moments. A gel made up of 2.5% of the acrylamide sodium acrylate copolymer with 0.24% ammonium persulfate was tested at 30 minutes after the fluid reached 79-82 deg C.: the gel could sustain its own weight when the bottle was placed upside down. After about 40 hours in the oven, obvious syneresis was seen in the gel. The gel could not hold itself when the bottle was turned upside down. Slight shaking broke the gel into pieces which were floating in the liquid produced by the gel syneresis. The pieces did not dissolve in fresh water. It is speculated that ammonium persulfate further polymerizes the polyacrylamide (increasing its molecular weight) that induces the syneresis and weakens the mechanical properties of the gel. The observation from the bottle tests is consistent with the viscometer tests. The difference between them is that there is additional shear action on the gel in the viscometer that results in the gel breaking quicker.

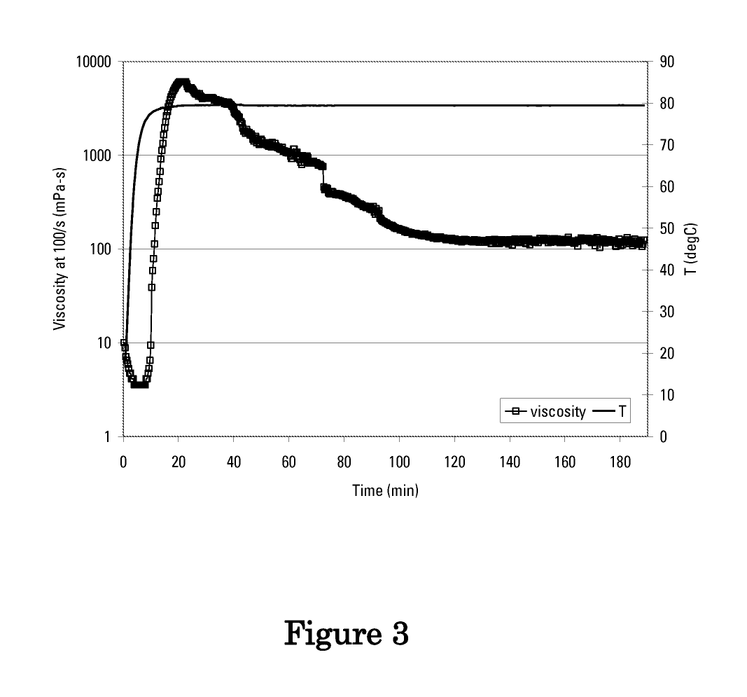

A more stable form of persulfate (sodium persulfate) was also tested. A concentration of 2.5% of the acrylamide sodium acrylate copolymer was dissolved in water and fully hydrates. The solution was then loaded into a Fann50-type viscometer with the addition of 0.24% sodium persulfate. In FIG. 3, the fluid viscosity began to rise abruptly at about 10 minutes and quickly reached over 5000 cP within minutes. The fluid viscosity then slowly decreased. After the measurement, the fluid was a liquid-like substance without obvious gel domains at room temperature.

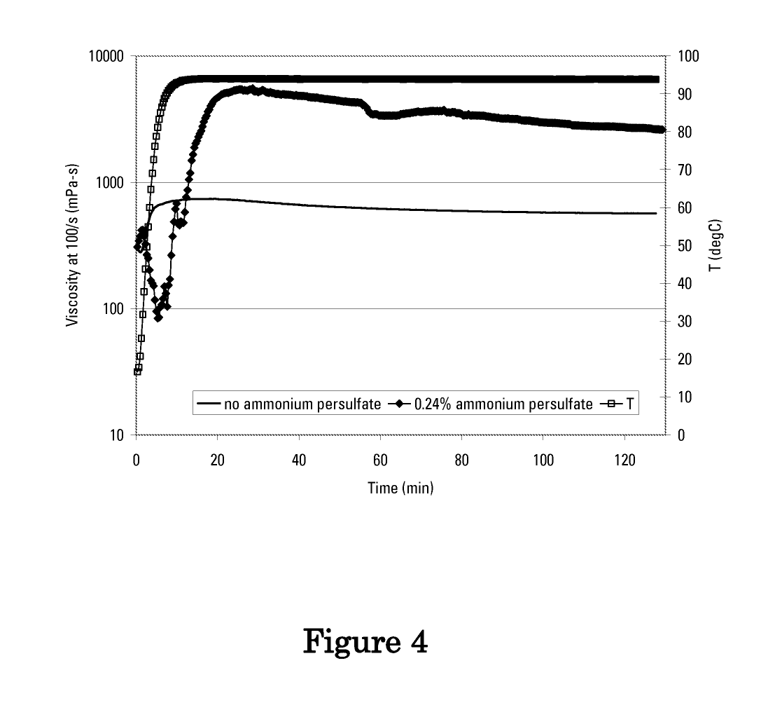

In a second example, the acrylamide sodium acrylate copolymer used has a higher molecular weight than previously considered (about 5 million). The petroleum oil-dispersed acrylamide sodium acrylate copolymer used here contained about 50% by weight of the higher molecular weight acrylamide sodium acrylate copolymer. The petroleum oil-dispersed acrylamide sodium acrylate copolymer was dissolved in water and allowed full hydration. The solution was then loaded into a Fann50-type viscometer with the appropriate amount of ammonium persulfate added. In FIG. 4, the solution of 3% of the petroleum oil-dispersed acrylamide sodium acrylate copolymer shows a viscosity of less than 1000 cP (at shear rate of 100/s) at 93.3 deg C. The fluid after viscosity measurement looked more like a viscous liquid than a gel at room temperature. With the presence of 0.24% ammonium persulfate, the fluid viscosity began to rise abruptly at about 8 minutes and quickly reached over 5000 cP within minutes. The fluid viscosity then slowly decreased. Further decrease of the viscosity was expected if the test time had been extended beyond 2 hours. After the measurement (stopped at about 2 hours), the initial fluid was a rubber-like substance at room temperature. The test also suggests that this re-polymerization was not sensitive to the presence of other chemicals such as mineral oil existing in the petroleum oil-dispersed acrylamide sodium acrylate copolymer. When the concentration of the petroleum oil-dispersed acrylamide sodium acrylate copolymer was reduced to 2% in the starting solution, the re-polymerization was still observed, but to a lower degree.

The bottle tests were carried out in the oven at about 82 deg C. The polymer solution in the bottle was heated with a microwave oven to 82 deg C., and breaker was then added and mixed. A gel made up of 2% of the petroleum oil-dispersed acrylamide sodium acrylate copolymer with 0.48% ammonium persulfate was tested at 30 minutes after the fluid reached 82 deg C.: the gel could sustain its own weight when the bottle was placed upside down. After about 17 hours in the oven, obvious syneresis was seen in the gel. The gel could not hold itself when the bottle was turned upside down. Slight shaking broke the gel into pieces (“soaked” in the liquid produced by the syneresis). The pieces could not be dissolved in sufficient amount of water. Again, it is speculated that ammonium persulfate further polymerizes the polyacrylamide that induces the syneresis and weakens the mechanical properties of the gel.

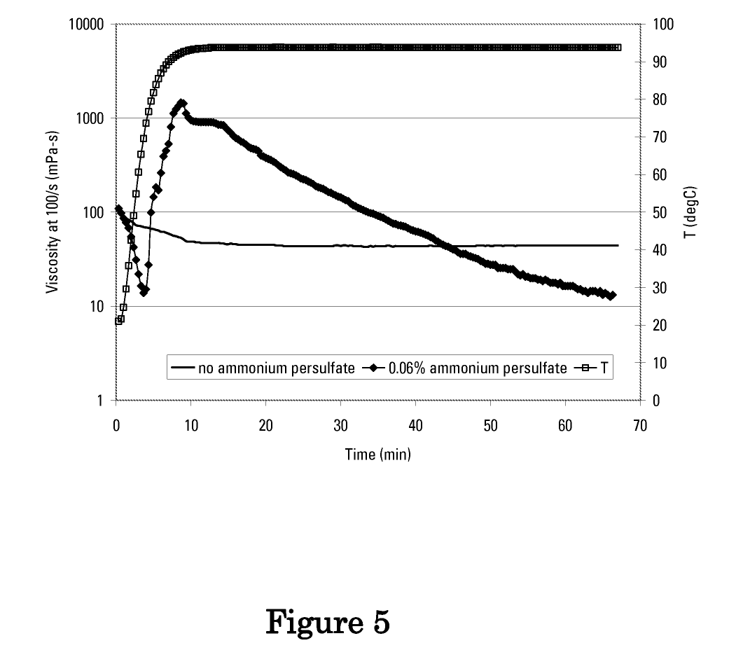

In a third example, self-breaking gels containing nonionic polyacrylamide were tested. Pure polyacrylamide (Fluka, nonionic water-soluble, with a molecular weight of about 5-6 million) was dissolved in water and allowed full hydration. The solution was then loaded into a Fann50-type viscometer with the appropriate amount of ammonium persulfate added. In FIG. 5, the solution of 1.5% of the polyacrylamide shows a stabilized viscosity of less than 50 cP (at shear rate of 100/s) at 93.3 deg C. The fluid after viscosity measurement looked like a viscous liquid at room temperature. With the presence of 0.06% ammonium persulfate, the fluid viscosity began to rise abruptly at about 4 minutes and quickly reached over 1400 cP within minutes. The fluid viscosity then decreased to below 100 cP at about 33 minutes. After the measurement, the fluid looked like a broken gel at room temperature.

In a further aspect, a post-cleaning of the self-breaking gels is described. In the case where these gels or broken gels need to be cleaned away, a number of methods were tested and proved to be effective. To dissolve the gel (formed with 2.5% acrylamide sodium acrylate copolymer and 0.24% ammonium persulfate), 0.3% sodium chlorite (80%) was added to the above gel, and the gel was placed into an oven at about 82 deg C. After about 1 day, the gel turned into liquid without obvious gel domains. In another example, the gel (formed with 2% of the petroleum oil-dispersed acrylamide sodium acrylate copolymer and 0.48% ammonium persulfate) had become a low viscosity liquid with 0.6% sodium chlorite (80%) at about 82 deg C. after a couple of days. Alternatively, the hydrogen peroxide breaker (BIO-ADD 1105, the stabilized hydrogen peroxide, about 30% hydrogen peroxide, Shrieve Chemical Products) can be used to break the gel domains into liquid. The gel (formed with 2.5% acrylamide sodium acrylate copolymer and 0.36% ammonium persulfate) was reduced to liquid with 2% of the hydrogen peroxide breaker at about 82 deg C. in less than 2 days.

These gels are obviously compatible with hydrocarbons such as mineral oil as suggested in the case of the petroleum oil-dispersed acrylamide sodium acrylate copolymer that itself contains mineral oil.

The gels were also found to be compatible with materials like proppants (silicate or ceramic). In one test, 100 ml of a proppant (Borden Ceramaxpg, sized 10/30) was placed in the bottle. About 50 ml of the aqueous solution of 2.5% acrylamide sodium acrylate copolymer and 0.24% ammonium persulfate was poured on top of the proppant pack. Due to the low viscosity at room temperature of the fluid, the fluid readily penetrated into the pore spaces between particles. A solid gel formed at about 82 deg C. from the solution inside the gaps of proppant particles and held when the bottle was placed upside down.

The particular embodiments disclosed above are illustrative only, as the invention may be modified and practiced in different but equivalent manners apparent to those skilled in the art having the benefit of the teachings herein. Furthermore, no limitations are intended to the details herein shown, other than as described in the claims below. It is therefore evident that the particular embodiments disclosed above may be altered or modified and all such variations are considered within the scope of the embodiments described herewith. Accordingly, the protection sought herein is as set forth in the claims below.

What is claimed is:

1. A method comprising:
a. injecting into a wellbore, a fluid comprising at least one of an acrylamide polymer and an acrylamide copolymer, and at least one of an oxidizing agent and a radical initiator;
b. allowing viscosity of the fluid to increase for a first period of time; and
c. subsequently, allowing viscosity of the fluid to decrease for a second period of time.

2. The method of claim 1, wherein the type of oxidizing agent or radical initiator changes the first period of time.

3. The method of claim 1, wherein the concentration of the oxidizing agent or the radical initiator changes the first period of time.

4. The method of claim 1, wherein the temperature changes the first period of time.

5. The method of claim 1, wherein the treatment comprises the step of creating a plug with the fluid.

6. The method of claim 5, wherein the fluid further comprises a crosslinker to create a more permanent plug.

7. The method of claim 6, wherein the crosslinker is chromium or aluminum, polyethyleneimine, hexamethylenetetramine with phenyl acetate, chemicals capable of forming aldehydes and phenolics or a combination thereof.

8. The method of claim 1, further comprising transforming the fluid into liquid with hydrogen peroxide, stabilized hydrogen peroxide, sodium chlorite, carbamide peroxide, urea peroxide, or combination thereof.

9. The method of claim 1, further comprising the step of temporary plugging with the fluid.

10. The method of claim 1, further comprising the step of creating diverting agent with the fluid.

11. The method of claim 1, further comprising the step of creating a kill pill with the fluid.

12. The method of claim 1, further comprising the step of creating a delayed acting friction reducer with the fluid.

13. A method of treating a subterranean formation from a wellbore comprising:
a. injecting into the wellbore, a fluid comprising at least one of an acrylamide polymer and an acrylamide copolymer, and at least one of an oxidizing agent and a radical initiator;
b. treating the subterranean formation by allowing viscosity of the fluid to increase for a first period of time; and subsequently, allowing viscosity of the fluid to decrease for a second period of time.

14. The method of claim 13, wherein the type of oxidizing agent or radical initiator changes the first period of time.

15. The method of claim 13, wherein the concentration of the oxidizing agent or the radical initiator changes the first period of time.

16. The method of claim 13, wherein the temperature changes the first period of time.

17. The method of claim 13, wherein the fluid contains acrylamide sodium acrylate copolymer.

18. The method of claim 13, wherein the acrylamide polymer and/or copolymer contains nonionic polyacrylamide.

19. The method of claim 13, wherein the oxidizer or radical initiator is persulfate, peroxide or a combination thereof.

20. The method of claim 19, wherein the persulfate is ammonium persulfate, sodium persulfate, potassium persulfate, or a combination thereof.

21. The method of claim 13, wherein the oxidizer or radical initiator is encapsulated.

22. A fluid comprising at least one of an acrylamide polymer and an acrylamide copolymer, and at least one of an oxidizing agent and a radical initiator, wherein concentration of the oxidizing agent or radical initiator is such that the fluid increases its viscosity for a period of time and after said period of time decreases its viscosity.

23. The fluid of claim 22, wherein the type of the oxidizing agent or radical initiator also affects the period of time.

24. The fluid of claim 22, wherein the temperature also affects the period of time.

25. The fluid of claim 22, containing acrylamide sodium acrylate copolymer.

26. The fluid of claim 22, wherein the acrylamide polymer and/or copolymer contains nonionic polyacrylamide.

27. The fluid of claim 22, wherein the oxidizer or radical initiator is persulfate, peroxide or a combination thereof.

28. The fluid of claim 27, wherein the persulfate is ammonium persulfate, sodium persulfate, potassium persulfate, or a combination thereof.

29. The fluid of claim 22, wherein the oxidizer or radical initiator is encapsulated.
